(19) United States
(12) Patent Application Publication
(10) Pub. No.: US 2020/0305409 A1
(43) Pub. Date: Oct. 1, 2020

(54) Thermal deck device for weed control

(71) Applicant: Gregory G. Prull, Eugene, OR (US)

(72) Inventor: Gregory G. Prull, Eugene, OR (US)

(21) Appl. No.: 16/873,367

(22) Filed: Mar. 26, 2020

Related U.S. Application Data
(60) Provisional application No. 62/919,748, filed on Mar. 26, 2019.

(51) Int. Cl. A01M 15/00

(52) U.S. Cl. CPC A01M 15/00; F23N 2241/18; F23D 2206/00

(57) ABSTRACT

A thermal deck device for weed control. The device includes a chassis having an axle means and a rotatable wheel located adjacent each end of the axle means. An enclosed deck is suspended from the chassis between the wheels and is vertically adjustable. A propane tank is removably attached to the upper planar surface of the enclosed deck. A handle structure is attached to the upper planar surface of the enclosed deck adjacent its rear end. A plurality of propane burners are located within the enclosed deck. Conduits communicate the propane tank with the propane burners via a valve located on the handle.

### CROSS-REFERENCE TO RELATED APPLICATIONS

This application claims the benefit of U.S. Provisional Application No. 62/919,748, filed Mar. 26, 2019, the entire contents of which are hereby incorporated by reference.

### BACKGROUND OF THE INVENTION

The present invention elates to a thermal deck device for weed control.

The use of herbicides and other chemicals to control weeds is environmentally unfriendly. One alternative is to use open flame burners. Some are hand held. Others are mounted on a cart to allow a user to more easily move the device over an area where weeds are to be controlled and to enable management of larger areas than a hand held device. Such currently available devices are inefficient as much of the heat is dissipated without performing any weed control function.

### SUMMARY OF THE INVENTION

It is an object of the present invention to provide a thermal deck device that greatly increases the amount of heat directed to weed control, thereby improving fuel efficiency and speed of use. The thermal deck weed control device of the present invention includes an enclosed deck having a generally rectangular-shaped metal deck roof that has substantially planar upper and lower surfaces.

Right and left metal sidewalls or skirts extend downwardly from the deck roof and are substantially perpendicular thereto. Each skirt has an inner and outer surface.

The thermal deck has a front skirt extending downwardly from the deck roof and is substantially perpendicular thereto. The front skirt has an opening or openings therein to allow communication between the interior of the enclosed deck and the exterior of the enclosed deck, thus allowing flames and exhaust gases to flow forwardly out there from with little or no turbulence, and helps protect them from being influenced by any wind. Preferably the opening is a single arched opening extending substantially to the top of the front skit and substantially to the ends of the front skirt.

The deck roof and skirts of the enclosed deck form a substantially rectangular combustion chamber that is open at its bottom.

The underside of the deck roof and the inside of the right and left side skirts are insulated, the insulation being held in place by metal cover means.

An expanded metal cover is located beneath the deck roof insulation and is attached to the underside of the roof deck. Right and left stainless steel sheets cover the insulation located on the right and left side skirts and are attached to the skirts. During operation the metal covers provide radiant heating which aids in the weed control process.

A plurality of propane burners are located within the combustion chamber adjacent the rear end of the enclosed deck with their burner ends directed towards the front end of the enclosed deck. The longitudinal axes of the burners are substantially parallel to the major plane of the deck roof.

Right and left flat skid members are attached to the lower right and left peripheral edges of the right and left side skirts, respectively. The front and rear ends of the right and left skid members extend beyond the front and rear ends of the thermal deck and are curved upwardly.

A propane tank holder is mounted on the thermal deck device and is configured to releasably hold a propane tank or other combustible fuel.

The propane tank communicates liquid or gaseous propane via tubing to the plurality of propane burners located within the combustion chamber via a valve.

An ignition mechanism can be located in the combustion chamber.

In a first embodiment the thermal deck is attached to a chassis that includes an axle with a rotatable wheel located adjacent each end thereof. The axle is horizontally adjustable to allow its length go be expanded or contracted to accommodate specific use requirements, such as along a fence line or wall.

In the first embodiment the chassis is provided with means that allow the thermal deck to be raised and lowered.

In the first embodiment a handle adapted to allow a user to push or pull the cart is attached to the rear end of the thermal deck device with a handle strut structure. The height of the handle is vertically adjustable to a location comfortable for the user. The handle is configured to allow horizontal movement from a central position to a right or left position to allow the user to walk in the aisle space between planting beds to prevent the user from walking on the beds.

In a second embodiment the thermal deck is provided with means to allow it to be attached to a boom that is attached to a tractor or other vehicle in a manner well known in the thermal weed control art.

### BRIEF DESCRIPTION OF THE DRAWINGS

FIG. 1 is a perspective upper view of the thermal deck device of the present invention;

FIG. 2 is an exploded view of the chassis and enclosed metal deck portion of the present invention;

FIG. 3 is a perspective bottom view of the enclosed metal deck portion of the thermal deck device;

FIG. 4 is a front view of the front skirt member of the enclosed metal deck portion of the thermal deck device; and

FIG. 5 is a cross-section view of the enclosed metal deck portion of the thermal deck device taken along line 5-5 of FIG. 3.

### DESCRIPTION OF PREFERRED EMBODIMENTS

In a first embodiment, the thermal deck device is a cart 10 having a chassis that includes an axle toolbar weldment 12 with right and left rotatable wheels 14 and 16 located adjacent the right and left ends thereof, respectively. Wheels 14 and 16 are horizontally adjustable via right and left wheel mount bracket members 14a and 14b to allow the distance between wheels 14 and 16 to be expanded or contracted.

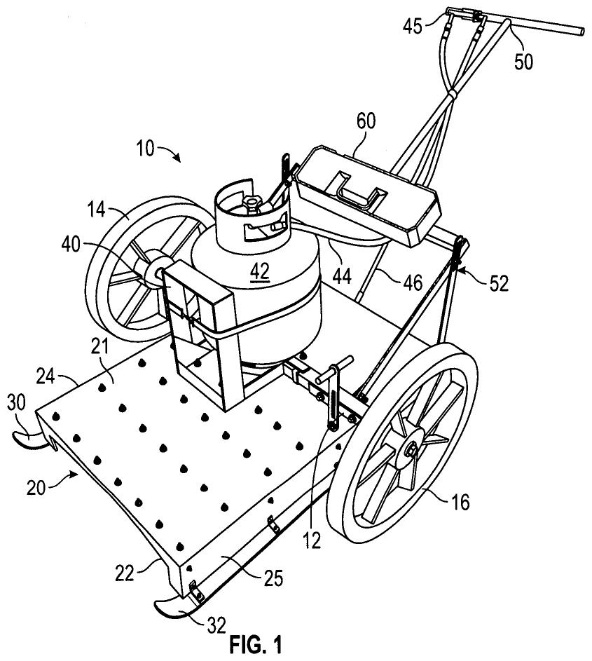

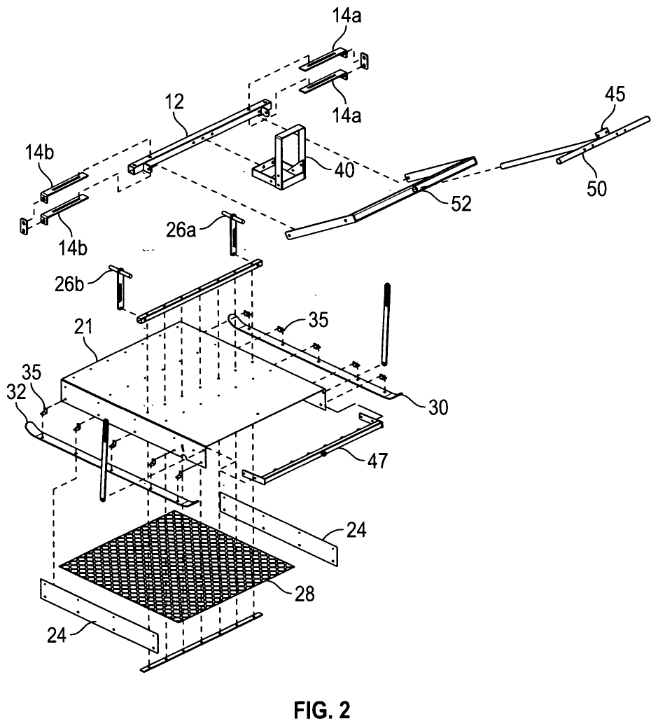

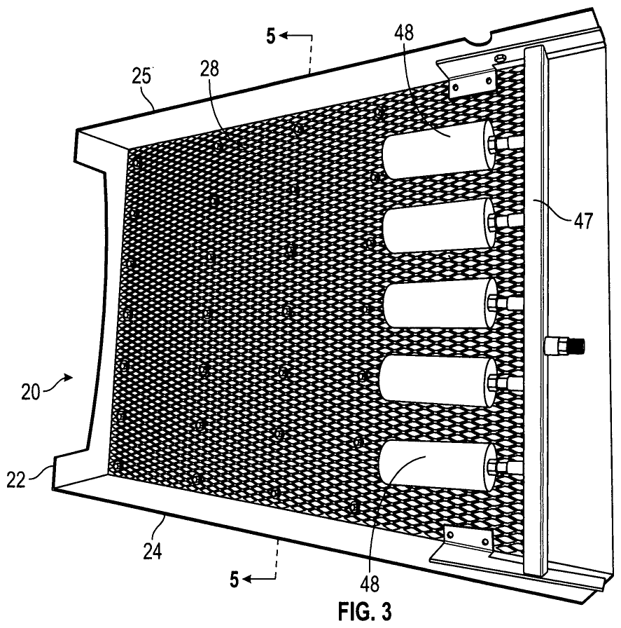

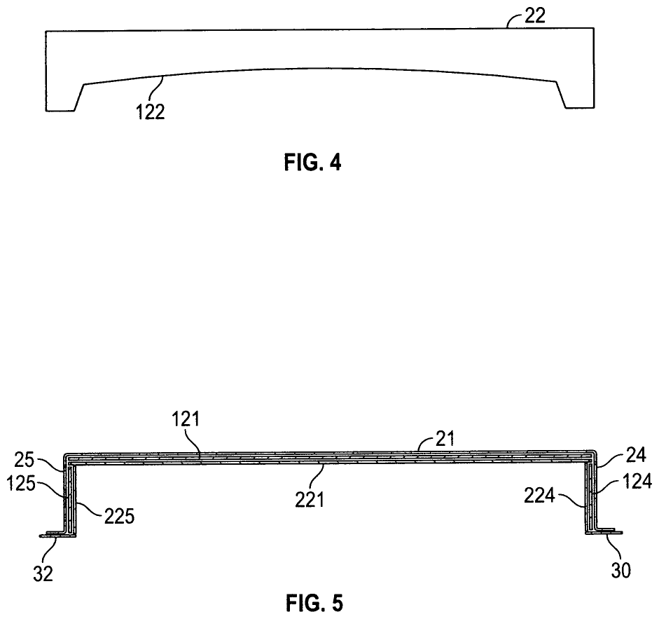

Mounted below the chassis is enclosed deck 20 having a metal roof member 21, front metal skirt member 22, and right and left metal side skirt members 24 and 25. Roof member 21 is substantially rectangular and has upper and lower substantially planar surfaces. Front skirt member 22 has an opening 122 therein which, preferably, is arched (as shown in FIGS. 1, 3, and 4). Skirt members 22, 24, and 25 extend vertically downward from the periphery of roof member 21 and, together with roof member 21, form a combustion chamber.

The lower planar surface of roof member 21 and the inner surfaces of right and left side skirt members 24, and 25 of the thermal deck 20 are insulated with insulation layers 121, 124, and 125, respectively, as shown in FIG. 5.

An expanded metal cover 221 is placed over the insulation underlying roof member 21 and attached to deck roof 21 by any suitable fastening means. Stainless steel plates 224 and 225 are placed over insulation layers 124 and 125, respectively, and attached to right and left side skirt members 24 and 25 by suitable fastening members. The metal covers 221, 224, and 225 provide radiant heating during use.

Enclosed deck 20 is suspended from the chassis by adjustable right and left lifters 26a and 26b in a manner that allows both course and fine vertical adjustment of the deck. Vertical adjustment of enclosed deck 20 allows the user to raise and lower the enclosed deck 20 in accordance with to the type of terrain being traversed.

Right and left flat skid members 30 and 32 are attached by skid brackets 35 to the lower edges of the right and left side skirt members 24 and 25 of enclosed deck 20, respectively, and

A handle 50 adapted to allow a user to push or pull the thermal deck device 10 is attached to the rear end 23 of the enclosed deck 20 on the upper surface of roof member 21 by means of strut structure 52.

The height of the handle 50 is vertically adjustable to a location comfortable for the user. The handle 50 is also adapted to allow horizontal movement from a central position to a right or left position to allow the user to walk in the space between crop beds.

A quick access weathertight toolbox 60 can be attached to handle strut structure 52.

In a second embodiment wheels 14 and 16 and handle mechanism 50 can be eliminated and means provided for attaching thermal deck 21 to a tractor or other vehicle via a boom mechanism (not shown). Such boom devices for flame type weed killing mechanisms are well known in the art.

It will be obvious to those having skill in the art that many changes may be made to the details of the above-described embodiments of his invention without departing from the underlying principles thereof. The scope of the present invention should, therefore, be determined only by the following claims.

The invention claimed is:

1. A thermal deck device for weed control comprising:
an enclosed deck having a top, bottom, front and rear ends, and opposing right and left side skirts
said enclosed deck including a deck roof located at the top thereof, said deck roof having upper and lower substantially planar surfaces;
said right and left side skirts extending downwardly from said deck roof, each of said right and left side skirts having an inner and outer surface;
said enclosed deck being open at its bottom;
said front end of said enclosed deck having a front skirt with at least one opening located therein;
said deck roof, front wall, and right and left side skirts forming a combustion chamber;
a plurality of burners located within said combustion chamber; and
conduits communicating said burners to a fuel source via a valve.

2. The thermal deck of claim 1 wherein said burners are located adjacent the rear end of said enclosed deck and within said combustion chamber.

3. The thermal deck of claim 2 wherein said burners are configured to direct their thermal output towards said front skirt of said enclosed deck.

4. The thermal deck of claim 3 wherein each of said burners has a longitudinal axis that is substantially parallel to said inner planar surface of said deck roof.

5. The thermal deck of claim 1 wherein said front skirt of said enclosed deck has an arched opening.

6. The thermal deck of claim 5 wherein said arched opening extends substantially to the top and ends of said front skirt.

7. The thermal deck of claim 1 wherein said lower planar surf ace of said deck roof and the inner surfaces of said right and left side skirts are insulated.

8. The thermal deck of claim 7 wherein each of said insulate surfaces includes a metal covering configured to hold said insulation in place and provide radiant heating during operation.

9. The thermal deck of claim 1 including a wheeled chassis attached to said enclosed deck.

10. The thermal deck of claim 9 including a handle attached to said chassis.

11. A thermal deck device for weed control comprising:
a chassis including an axle means and a rotatable wheel located adjacent each end of said axle means;
an enclosed deck suspended from said chassis and located between said wheels, said enclosed deck having a top, bottom, front and rear ends, and opposing fight and left side skirts;
said enclosed deck including a deck roof located at the top thereof, said deck roof having upper and lower substantially planar surfaces;
a propane tank removably attached to said upper planar surface of said enclosed deck;
a handle structure attached to the upper planar surface of said enclosed deck adjacent its rear end;
a plurality of propane burners located within said enclosed deck; and
conduits communicating said propane tank with said propane burners via a valve located on said handle.
